(19) United States
(12) Patent Application Publication
(10) Pub. No.: US 2010/0088145 A1
(43) Pub. Date: Apr. 8, 2010

(54) METHOD AND COMPUTER FOR CREATING COMMUNICATOR'S SCHEDULE

(75) Inventor: Toshiyuki Omiya, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: P & W Solutions Co. Ltd., Shinagawa-ku Tokyo (JP)

(21) Appl. No.: 12/524,851

(22) PCT Filed: Jan. 25, 2008
(86) PCT No.: PCT/JP2008/051049

§ 371 Date: Jul. 28, 2009

(30) Foreign Application Priority Data
Jan. 29, 2007 (JP) 2007-018572

(51) Int. Cl. G06Q 10/00; G06Q 50/00

(52) U.S. Cl. 705/9

(57) ABSTRACT

A computer (server 10) stores at least data describing the skills of each of a plurality of communicators in a storage unit (120). The computer receives, from a manager at a contact center, an input for specifying the number of communicators to be assigned to each of a plurality of skills of communicators for each time period of a task, and further stores data describing the number of personnel designated by the received input into the storage unit (120) for each time period of the task. According to the stored data describing the number of personnel, the computer creates the schedules of the plurality of communicators for each time period of the task.

### TECHNICAL FIELD

The present invention relates to a method and computer for creating a schedule for a communicator.

### BACKGROUND ART

Recently, contact centers, which have become a frontier of communication using telephone, e-mail, and the like with customers, have become more and more important for corporations. Furthermore, the communicator (also called an “operator”), who is an person responsible for communication using telephone or e-mail at the contact center, takes charge of customer service as what can be called a corporate representative. Therefore, their customer service skills greatly influence trust in the corporation.

In this kind of situation, the technology of scheduling a communicator having skills commensurate with the content of incoming calls or arriving e-mail messages has gained attention. For example, in Patent Document 1, a personal information management means for storing and managing a skill level for each communicator, and a method of distributing tasks of a call center to operators based on the skill level stored in the personal information management means, are disclosed.

Patent Document 1: Japanese Unexamined Patent Application Publication No. 2006-211395

### DISCLOSURE OF THE INVENTION

### Problems to be Solved by the Invention

However, according to the technology described in Patent Document 1, even if it is possible to assign a project to a communicator with matching skills from among communicators already scheduled and actually placed, the technology to create a schedule itself for a communicator having skills matching predicted inquiry content, based on skills of a communicator, from among communicators who can be scheduled, has not been disclosed. Furthermore, technology specifically indicating a skill profile of a communicator to be scheduled and adjusting the schedule has not been disclosed.

Therefore, the present invention has the objective of providing a method and computer for creating a schedule itself for a communicator having a skill matching predicted inquiry content, based on skills of communicators, from among communicators who can be scheduled, and for managing a skill of the communicator. In addition, an objective is to provide a method and computer for specifically indicating a skill profile of a communicator to be placed, and adjusting a schedule.

### Means for Solving the Problems

The present invention, more specifically, provides the following.

According to a first aspect of the present invention, a method for creating schedules for a plurality of communicators of a contact center by a computer,

wherein the computer stores at least data indicating a skill of each of the plurality of communicators in a storage unit; the method comprising steps of:

accepting a designated input of a number of the communicators to be placed, for each of a plurality of skills of the communicators for each of the time periods of a task, from a manager of the contact center;

further storing, in the storage unit, data indicating a number of personnel who have accepted the designated input for each time period of the task; and

creating a schedule of the plurality of communicators, based on data indicating the stored number of personnel for each time period of the task.

By including this type of configuration of the present invention, the computer: stores, in the storage unit, at least data indicating each of the skills of the plurality of communicators;

accepts a designated input of a number of the communicators to be placed for each of the plurality of skills of the communicators for each of the time periods of a task from a manager of the contact center;

further stores, in the storage unit, data indicating a number of personnel who have accepted the designated input for each time period of the task; and

creates a schedule for the plurality of communicators, based on data indicating the stored number of personnel for each time period of the task.

Therefore, it is possible for the computer to create schedules for the plurality of communicators based on designated input of a number of the communicators to be placed for each of the plurality of skills of the communicators for each of the time periods of a task.

As a result, it is possible for the computer to manage a skill of the communicator, and to create a schedule in order to place a communicator having a skill matching contents of a predicted inquiry, based on skills of communicators, from among communicators who can be scheduled. In addition, it is possible for the computer specifically to indicate a skill profile of a communicator to be placed, and to adjust a schedule.

According to a second aspect, in the method according to the first aspect of the present invention,

the computer stores, in the storage unit, each skill of the plurality of communicators by dividing into a plurality of levels;

the computer further accepts designated input of the level from the manager, in the step of accepting the designated input;

the computer further stores, in the storage unit, the level for which the designated input was accepted, in the step of storing; and

the schedule is created based on the level further stored, in the step of creating the schedule.

By providing this type of configuration of the present invention, the computer: stores, in the storage unit, each skill of the plurality of communicators by dividing into a plurality of levels;

further accepts a designated input of the level from the manager;

further stores, in the storage unit, a level for which the designated input was accepted; and

creates the schedule based on the level further stored.

As a result, it is possible for the computer to manage not only a skill of the communicator, but also a level thereof, and to create a schedule to place a communicator having a skill and skill level matching contents of a predicted inquiry. Furthermore, it is possible for the computer specifically to indicate a profile including even a skill level of a communicator to be placed, and to adjust a schedule.

According to a third aspect of the present invention, in the method according to either the first or second aspect,

the computer further stores in the storage unit data indicating a job title for each of the plurality of communicators;

the computer further accepts a designated input of the number of the communicators to be placed for each of the plurality of job titles of the communicators for each of the time periods of the task from the manager, in the step of accepting the designated input;

the computer further stores in the storage unit data indicating the number of personnel for which the designated input was accepted, in the step of storing; and

the computer creates the schedule based on data indicating the job title further stored, in the step of creating the schedule.

By providing this type of configuration of the present invention, the computer: further stores, in the storage unit, data indicating a job title of each of the plurality of communicators;

further accepts a designated input of the number of communicators to be placed for each of the plurality of job titles of the communicators for each time period of the task;

further stores, in the storage unit, data indicating the number of personnel for whom the designated input was accepted; and

creates the schedule based on data indicating the job title further stored.

As a result, it is possible for the computer to create a schedule managing not only a skill and a skill level of the communicator, but also including the job title thereof, and to place a communicator having a job title matching contents of a predicted inquiry. In addition, it is possible for the computer to indicate specifically a profile including even a job title of a communicator to be placed, and to adjust a schedule accordingly.

In a fourth aspect of the present invention, the method according to any one of the first to third aspects, further includes steps of the computer:

accepting input of data indicating a desired weekly holiday and a desired shift of the communicator; and

adjusting the created schedule based on data indicating the desired weekly holiday and desired shift for which the input was accepted, in the step of creating the schedule.

By including this type of configuration of the present invention, the computer: accepts input of data indicating the desired weekly holiday and desired shift of the communicator; and

adjusts the created schedule based on data indicating the desired weekly holiday and desired shift for which the input was accepted.

Therefore, it is possible for the computer to adjust the created schedule based on the desired weekly holiday and desired shift of the communicator.

As a result, it is possible for the computer to reflect the desired weekly holiday and desired shift of the communicator as much as possible on the created schedule.

According to a fifth aspect of the present invention, the method according to any one of the first to fourth aspects includes:

a step of the computer further storing, in the storage unit, a past absence rate of the communicator by day of week or by time period,

wherein the computer creates the schedule based on the stored absence rate, in the step of creating the schedule.

By providing this type of configuration of the present invention, the computer: further stores, in the storage unit, a past absence rate of the communicator by day of week or by time period, and

creates the schedule based on the stored absence rate.

Therefore, it is possible for the computer to create the schedule based on a past absence rate of the communicator by day of week or time period.

As a result, it is possible for the computer to create a schedule having suitable leeway according to the past absence rate of the communicator by day of week or time period.

In a sixth aspect of the present invention, the method according to any one of the first to fifth aspects further includes:

a step of the computer calculating and displaying a rate of filled vacancy based on the number of personnel for whom the specific input was accepted, and the number of personnel actually placed.

By providing this type of configuration of the present invention, the computer calculates and displays a filled vacancy rate based on the number of personnel for whom the specific input was accepted, and the number of personnel actually placed.

As a result, it is possible for the computer, for example, to calculate a filled vacancy rate indicating a ratio of a number of personnel actually placed to a number of personnel to be placed for each of a plurality of contracted employment agencies, and to display thereof to a manager.

In a seventh aspect of the present invention, the method according to any one of the first to sixth aspects further includes steps of the computer:

accepting an input from the manager converting a portion of a vacation period of the communicator to a work period in relation to the created schedule;

accepting a designation of a predetermined period; and

calculating and displaying a period which can be set for a compensation vacation period of the communicator in relation to the created schedule in the predetermined period for which a designation was accepted.

By providing this type of configuration of the present invention, the computer: accepts an input from the manager within a vacation period of a communicator of a portion to be changed to a work period in relation to the created schedule;

accepts a designation of a predetermined period; and

calculates and displays a period to be set of a compensation vacation period of the communicator in relation to the created schedule in the predetermined period for which a designation was accepted.

Therefore, it is possible for the computer to calculate a period to be set of a compensation vacation period of the communicator in the accepted predetermined period in relation to a schedule of a communicator for which a portion of a vacation period has been changed to a work period, and to display thereof to a manager.

As a result, it is possible for the computer to display to a manager, in a case of ordering a large number of days of work on a national holiday, for example Golden Week, information for suitably adjusting a schedule for acquiring a compensation vacation period for a communicator, according to predicted inquiries and the like.

According to an eighth aspect of the present invention, in the method according to any one of the first to seventh aspects, wherein the computer:

further stores, in the storage unit, early shift and overtime availability data indicating whether each communicator is available for an early shift and/or overtime, and maximum overtime hour data indicating available maximum overtime hours, respectively; and

creates the schedule based on the early shift and overtime availability data and the maximum overtime hour data further stored, in the step of creating the schedule.

By providing this type of configuration of the present invention, the computer: additionally stores, in the storage unit, early shift and overtime availability data indicating whether each communicator is available for an early shift and/or overtime, and maximum overtime hour data indicating available maximum overtime hours for each; and

creates the schedule based on the early shift and overtime availability data and the maximum overtime hour data further stored.

Therefore, it is possible for the computer, in a case in which a deficiency of communicators occurs for a particular time period, instead of scheduling a new communicator, to create a type of schedule in which the deficiency can be resolved as much as possible by setting up an early shift and/or overtime for communicators already scheduled.

In an ninth aspect of the present invention, the method according to any one of the first to eighth aspects further includes steps of the computer:

accepting from the manager designated input of each service target upon designation of the skill for each time period of each task; and

further storing, in the storage unit, data indicating the service target for which the designated input has been accepted upon designation of the skill for each time period of the task,

wherein the computer creates the schedule based on data indicating the service target further stored, in the step of creating the schedule.

By providing this type of configuration of the present invention, the computer: accepts from the manager a designated input of each service target upon designation of the skill for each time period of the task;

further stores, in the storage unit, data indicating the service target for which the designated input has been accepted upon designation of the skill for each time period of the task; and

creates the schedule based on data indicating the service target further stored.

Therefore, it is possible for the computer to create the schedule based on data indicating each accepted service target for which the skill has been designated for each time period of each task.

As a result, it is possible for the computer, for example, to reflect in the schedule such a service target as a response rate for within a designated time for each time period of the task upon designation of the skill.

In this manner, it is possible for the computer, upon accepting a designation of detailed service level that should be achieved for each time period and for each of the skills, to create a schedule reflecting the service level.

According to a tenth aspect of the present invention, in a computer that creates a schedule for a plurality of communicators of a contact center,

wherein at least data indicating a skill for each of the plurality of communicators is stored in a storage unit; the computer includes:

a unit configured to accept a designated input of a number of the communicators to be placed for each of a plurality of skills of the communicators for each time period of the task from the manager of the contact center;

a unit configured to store further, in the storage unit data indicating the number of personnel for whom the designated input was accepted for each time period of the task; and

a unit configured to create a schedule for the plurality of communicators based on data indicating the stored number of personnel for each time period of the task.

By providing this type of configuration of the present invention, the computer: stores, in the storage unit, at least data indicating a skill for each of the plurality of communicators;

accepts a designated input of the number of communicators to be placed for each of the plurality of skills of the communicators for each time period of the task from the manager of the contact center;

further stores, in the storage unit, data indicating the number of personnel for whom the designated input has been accepted for each time period of the task; and

creates a schedule for the plurality of communicators based on data indicating the stored number of personnel for each time period of the task.

As a result, it is possible for the computer to achieve an effect similar to that of the first aspect.

### EFFECTS OF THE INVENTION

According to the present invention, it is possible for the computer to create a schedule for a plurality of communicators based on designated input of the number of communicators to be placed for each of the plurality of skills of the communicators for each time period of the task. As a result, it is possible for the computer to manage a skill of a communicator, as well as to create a schedule placing a communicator having a skill matching contents of a predicted inquiry based on a skill of a communicator from among communicators who can be scheduled. In addition, it is possible for the computer specifically to indicate a skill profile of a communicator to be placed, and to adjust the schedule.

### BRIEF DESCRIPTION OF THE DRAWINGS

FIG. 1 is a diagram showing an overall framework of a system 1 according to a preferred embodiment of the present invention;

FIG. 2 is a diagram showing a framework of a server 10 and a terminal 20 according to a preferred embodiment of the present invention;

FIG. 3 is a flowchart showing a flow of schedule creation processing on the server 10 shown in FIG. 1 according to a preferred embodiment of the present invention;

FIG. 4 is a diagram showing an input screen for schedule creation processing according to a preferred embodiment of the present invention;

FIG. 5 is a diagram showing an input screen for schedule creation processing according to a preferred embodiment of the present invention;

FIG. 6 is a diagram showing an input screen for schedule creation processing according to a preferred embodiment of the present invention;

FIG. 7 is a diagram showing an input screen for schedule creation processing according to a preferred embodiment of the present invention;

FIG. 8 is a diagram showing an input screen for schedule creation processing according to a preferred embodiment of the present invention;

FIG. 9 is a diagram showing an input screen for schedule creation processing according to a preferred embodiment of the present invention;

FIG. 10 is a diagram showing an input screen for setting of absence rate according to a preferred embodiment of the present invention;

FIG. 11 is a diagram showing data for each communicator according to a preferred embodiment of the present invention;

FIG. 12 is a flowchart showing a flow of compensation vacation period configuration processing on a server 10 and a terminal 20 according to a preferred embodiment of the present invention; and

FIG. 13 is a diagram showing an example of a display of a filled vacancy rate according to a preferred embodiment of the present invention.

### PREFERRED MODE FOR CARRYING OUT THE INVENTION

Hereinafter, a preferred embodiment of the present invention is explained based on the diagrams.

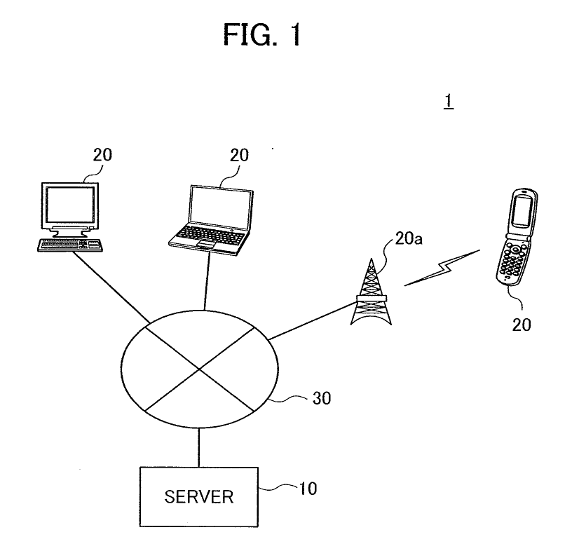

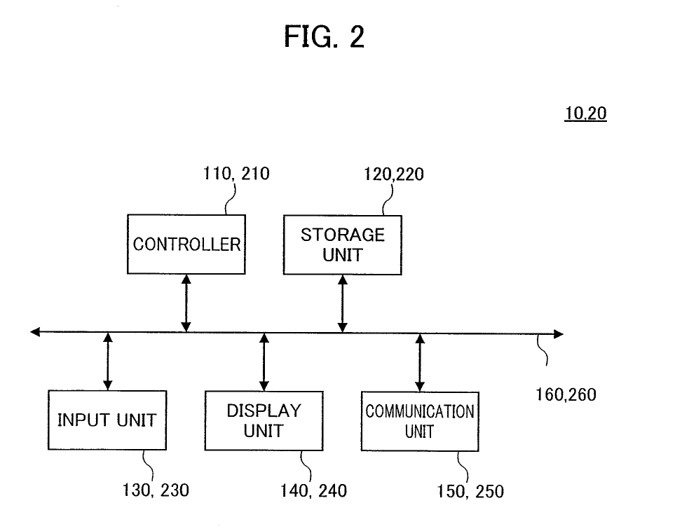

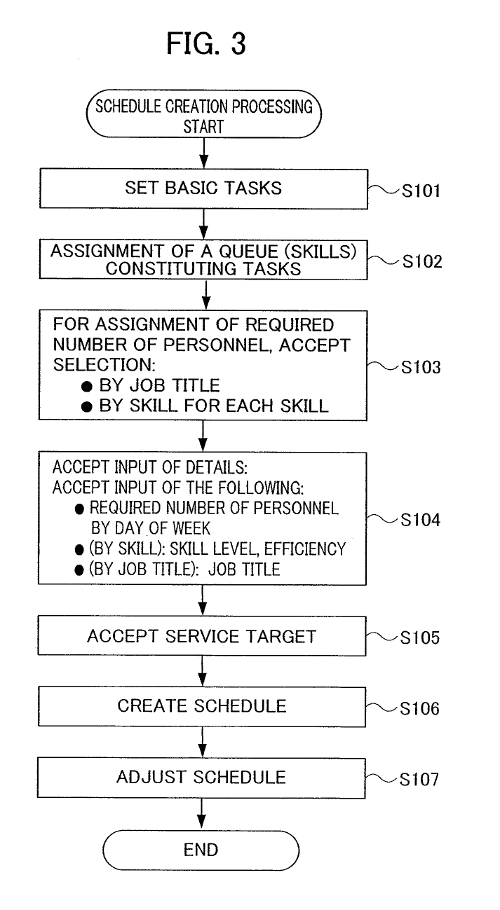

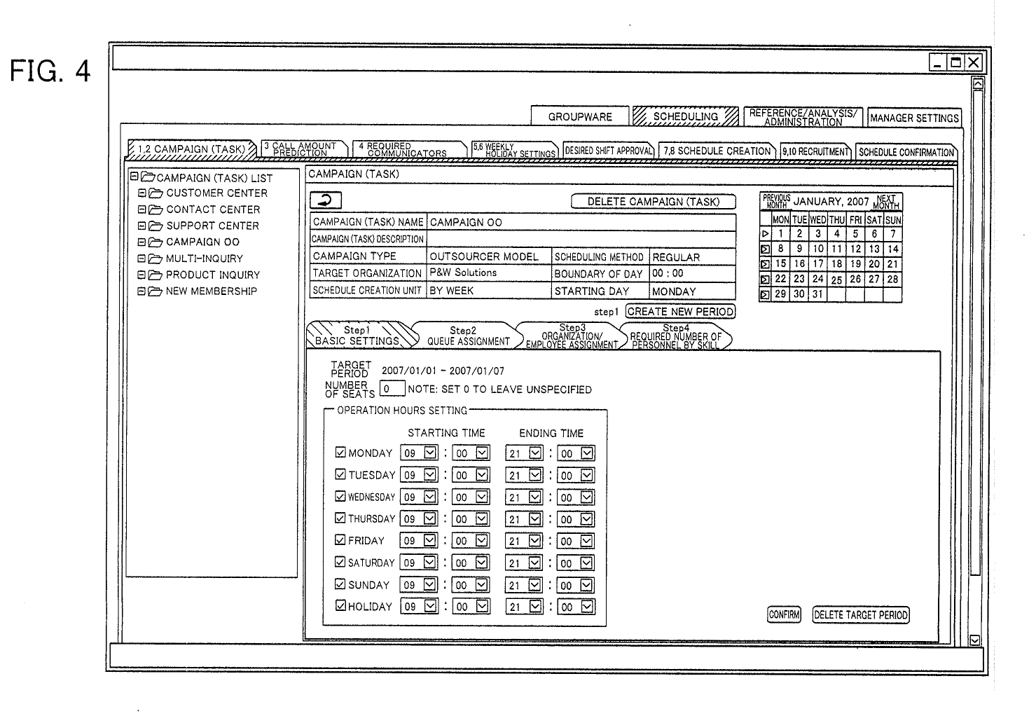

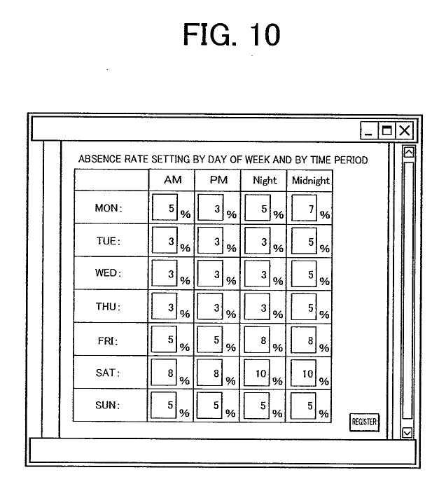

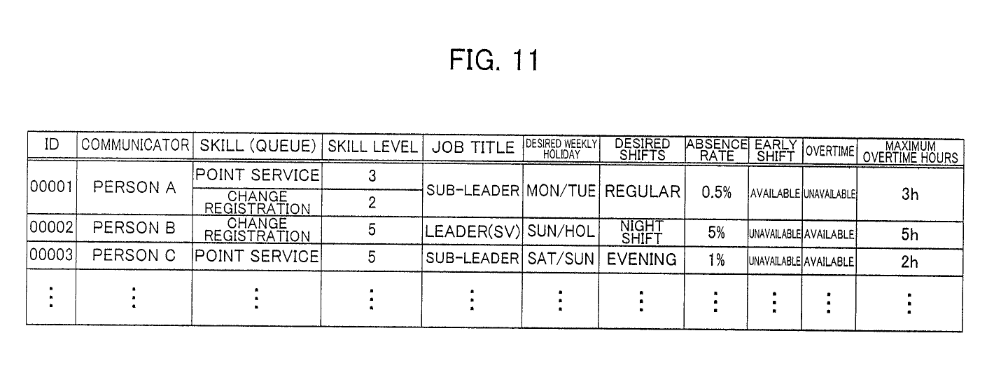

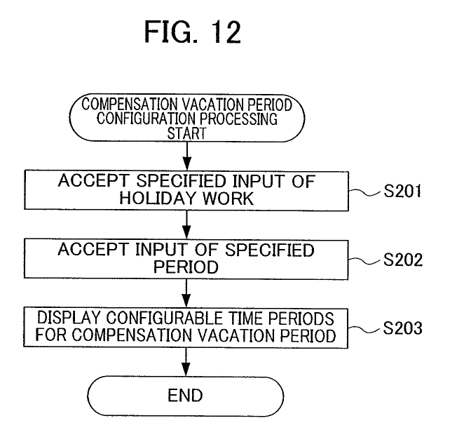

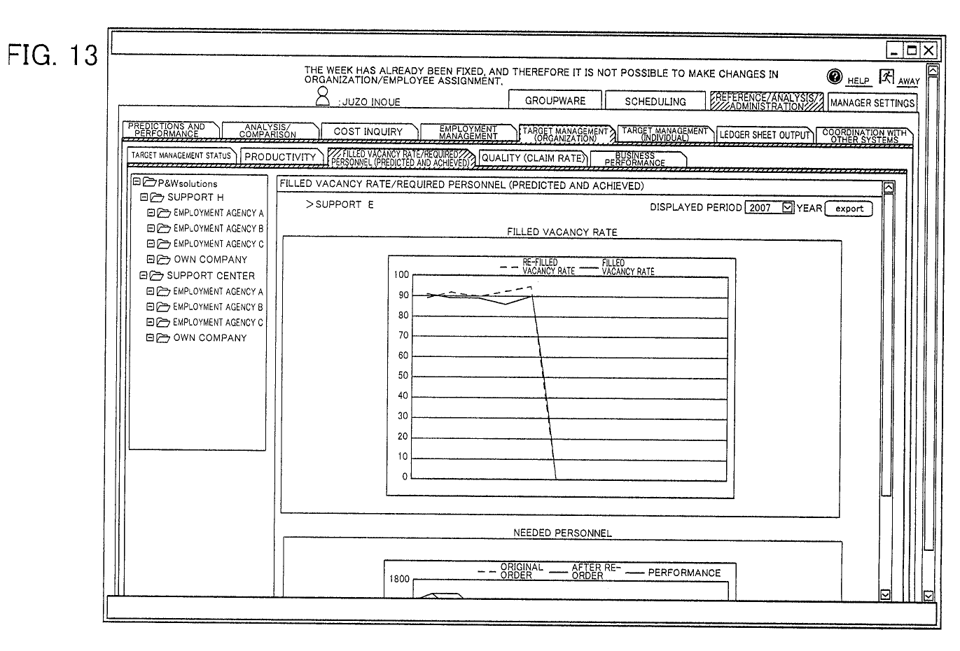

FIG. 1 is a diagram showing an overall framework of a system 1 according to a preferred embodiment of the present invention. FIG. 2 is a diagram showing a framework of a server 10 and a terminal 20 according to a preferred embodiment of the present invention. FIG. 3 is a flowchart showing a flow of schedule creation processing on the server 10 shown in FIG. 1 according to a preferred embodiment of the present invention. FIGS. 4 to 9 are diagrams showing an input screen for schedule creation processing according to a preferred embodiment of the present invention. FIG. 10 is a diagram showing an input screen for setting of absence rate according to a preferred embodiment of the present invention. FIG. 11 is a diagram showing data for each communicator according to a preferred embodiment of the present invention. FIG. 12 is a flowchart showing a flow of compensation vacation period configuration processing on a server 10 and a terminal 20 according to a preferred embodiment of the present invention. FIG. 13 is a diagram showing an example of a display of a filled vacancy rate according to a preferred embodiment of the present invention.

### Overall Framework of the System

FIG. 1 is a diagram showing an overall framework of a system 1 according to a preferred embodiment of the present invention.

The server 10 is connectable to the terminal 20 through the communication network 30.

Furthermore, the communication network 30 connecting the terminal 20 and the server 10 can not only be that which is achieved by wire, but can also be achieved through various communication networks matching the technical concept of the invention, such as that achieved wirelessly by a part via a base station 20a, such as by a mobile phone, that achieved by a wireless LAN via an access point, or the like.

### Hardware Framework of the Server 10

As shown in FIG. 2, a controller 110, storage unit 120, input unit 130, display unit 140, and communication unit 150 are connected through a bus 160, and configure the server 10 thereof.

The controller 110 may be configured by a CPU (Central Processing Unit), and controls the entirety of the server 10, for example, by reading and executing a program stored in the storage unit 120 in cooperation with this hardware, to achieve various functions to be described hereinafter.

The storage unit 120 can be achieved by a hard disk, semiconductor memory, or the like. The input unit 130 can be achieved by a keyboard, mouse, or the like. The display unit 140 can be achieved by an LCD display, CRT, or the like. The communication unit 150 can be achieved by a LAN adapter, modem adapter, or the like.

The above-described examples were mainly explained in regards to the server 10; however, it is also possible for a program to be installed on the computer, and for that computer to be operated as a server device, thereby achieving the functions described above. Therefore, the functions to be achieved by the server described as a preferred embodiment of the present invention can be achieved by executing the above-described method on the computer, or alternatively also by installing the above-described program on the computer and executing thereof.

### Hardware Framework of the Terminal 20

Here, the terminal 20 may include a similar configuration to that of the above-described server 10. It should be noted that the terminal 20 may be achieved as a communication terminal other than a personal computer (PC), such as a mobile phone, PDA (Personal Digital Assistant), or the like.

A controller 210, storage unit 220, input unit 230, display unit 240, and communication unit 250 are connected by the bus 260 and configure the terminal 20 thereof.

### Schedule Creation Processing

FIG. 3 is a flowchart showing a flow of schedule creation processing on the server 10 shown in FIG. 1. Hereinafter, schedule creation processing is explained based on FIGS. 3 to 10. It should be noted that, in the following explanation, various processing is executed by only the server 10, but may also be executed by a system 1 including a terminal 20 connected through a communication network 30. In that case, the computer according to the present invention may be achieved by a system 1 including a server 10, terminal 20, and communication network 30.

Here, the storage unit 120 of the server 10 stores a skill of each communicator (also called an “operator”) of a contact center (also called a “call center”). A manager of the contact center can input a number for each item for which the skill has been determined beforehand. Furthermore, such positions of each communicator as a department chief, supervisor, and the like can be similarly input.

First, in Step S101, the controller 110 of the server 10 accepts a selection of a campaign (task) from among a list of campaigns (tasks) from the input unit 130, and accepts input of a basic setting specifying a work time of the selected task by day of week. As a more specific example of an input screen, an explanation is given with reference to FIG. 4.

In the example of FIG. 4, “Campaign OO” has been selected from among a list of campaigns (tasks). Furthermore, in relation to a target week of from Jan. 1, 2007 to Jan. 7, 2007, a situation of input being accepted for an “operation hours setting” that sets operation hours by day of week is shown. The manager, in this manner, can specify a time period of a campaign (task) for which a schedule is to be set. Furthermore, it should be noted that a number of seats can be input, and a maximum number of personnel who can be seated at a contact center can be set.

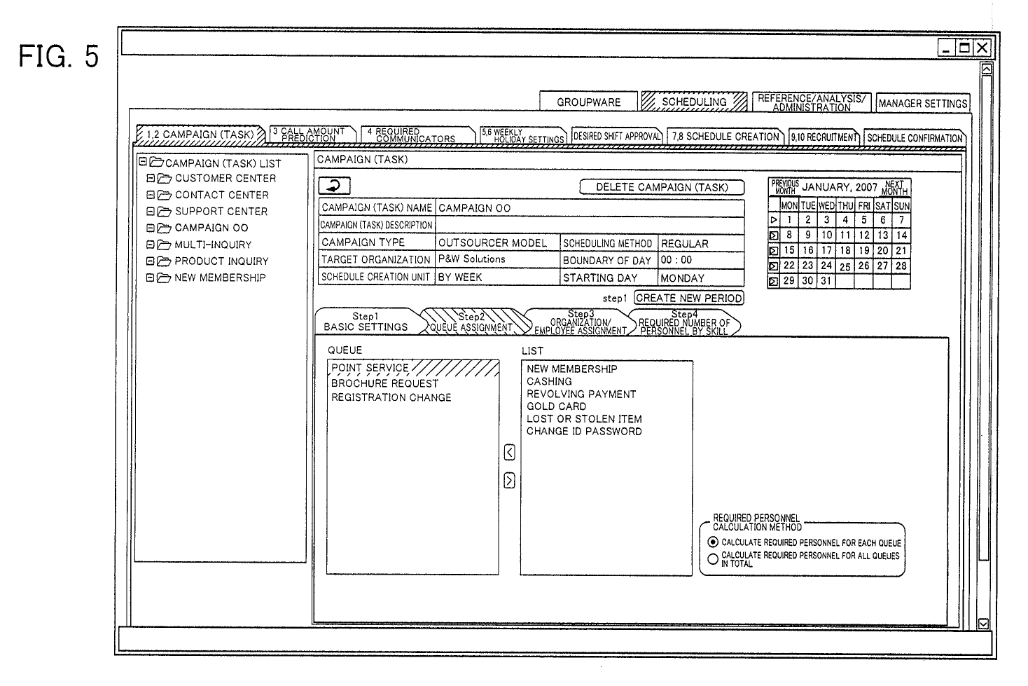

Next, in Step S102, the controller 110 of the server 10 accepts an input of assignment of a queue (skills) constituting tasks by way of an input unit 130. A more specific example of an input screen is explained with reference to FIG. 5.

FIG. 5 shows a situation of a queue (skills) required for “Campaign OO” being selected from among a list (queue). In this example, the queue (skills) of “point service,” “brochure request,” and “registration change” has been selected. It is possible for the manager, in this manner, to set a plurality of required queue items (skills) with respect to “Campaign (Task): Campaign OO.”

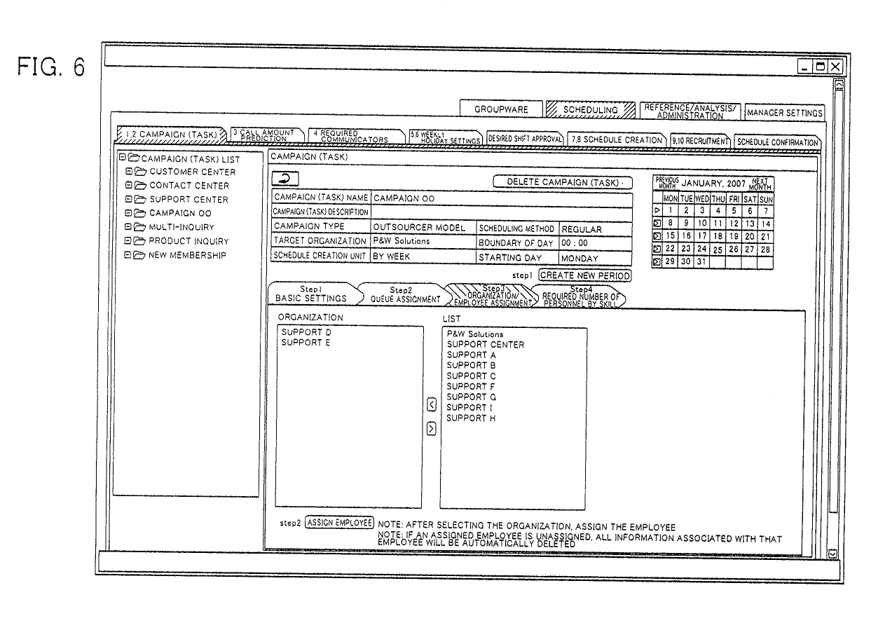

Next, the controller 110 of the server 10, upon accepting a setting such as of a team performing a task for Campaign OO or such an organization as an outsourcing company, additionally accepts an input setting of employee assignment of communicators to be assigned by way of the input unit 130. A more specific example of an input screen is explained with reference to FIG. 6.

FIG. 6 shows a situation of “Support D, Support E” being selected from a list. By performing this kind of employee assignment, it is possible for the manager to specify a candidate in order to perform an assignment of a communicator for performing a task for Campaign OO.

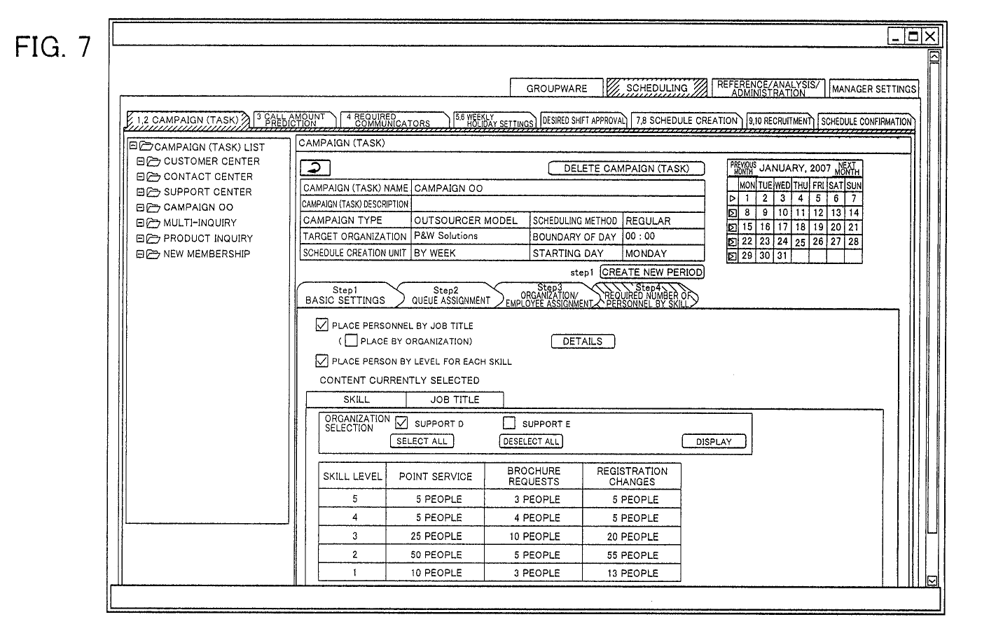

Next, in Step S103, the controller 110 of the server 10 accepts input of a number of communicators, skill levels, job titles, and the like constituting a minimum team to be maintained in a time period of which a call amount is zero by way of the input unit 130. A more specific example of an input screen is explained with reference to FIG. 7.

FIG. 7 shows a state in which skill levels, number of personnel, and the like of candidates for communicators who can be placed, based on an organization/employee assignment designated in the screen of FIG. 6, are displayed. In this manner, it is possible for the manager, upon confirming information of skill levels and the like for communicators who can be placed on screen, to perform designation of a number of personnel, skill levels, job titles, and the like for communicators constituting a minimum team. In the example of FIG. 7, skill levels and the like for candidates, such as “Point Service, Skill Level 5: 5 people” and “Point Service, Skill Level 4: 5 people,” are displayed. It should be noted that, in a case in which the campaign (task) type is an outsourcing model including outsourcing to an outsourcing company, by selecting an organization (in the example of FIG. 7, for example, “Support D” or “Support E”) by inserting a check mark therein, and pressing the “Display” button, it is possible to confirm a number of personnel who can be assigned by skill level for each outsourcing company.

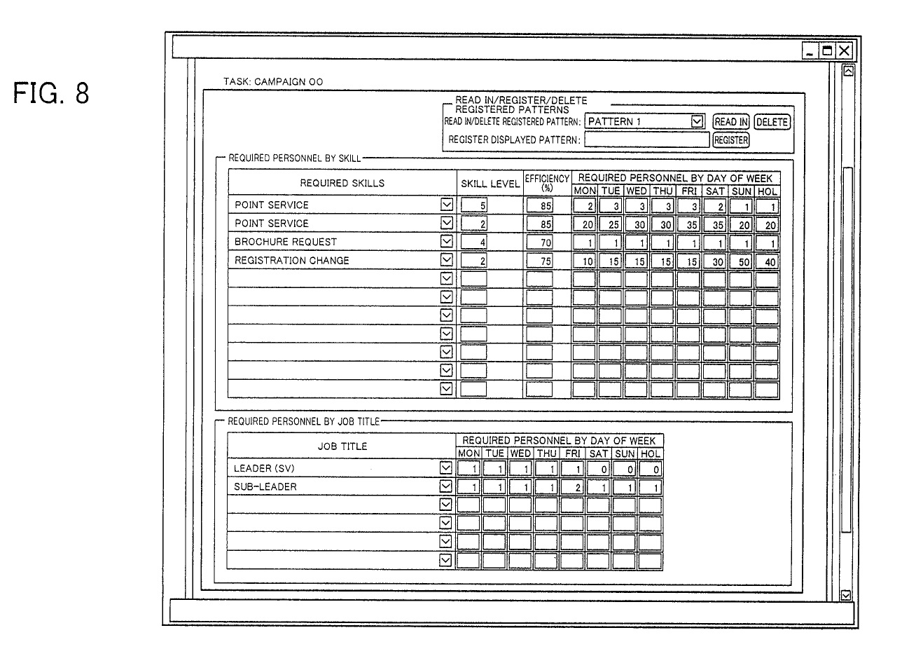

Next, in Step S104, the controller 110 of the server 10 accepts input of a detailed setting by skill and by job title using the input unit 130. A more specific example of an input screen is explained with reference to FIG. 8.

In the example of FIG. 8, input of required personnel by skill and by job title is being accepted. Furthermore, in relation to required personnel by each skill, input is accepted for required skills, skill level, efficiency, and required number of personnel by day of week. For example, in relation to “Required Skill: Point Service,” a required number of personnel and the like for each of the skill levels of “Skill Level: 5” and “Skill Level: 2” are being input. Furthermore, for the required personnel by job title, the job title and the required number of personnel by day of week are being input. For example, it is input that “Leader: Monday to Friday, one person” and “Sub-leader: one person for Saturday to Thursday, two people for Friday” are required. It should be noted that, by pattern-registering assignments of required personnel by skill and by job title set in this manner, and enabling pattern-reading from next time and later, it is possible to eliminate labor of similar input, and to increase efficiency of input.

Next, the controller 110 of the server 10 performs statistical calculations and the like based on past call amount data, creates prediction data of a call amount, and stores thereof. Here, the prediction data of a calculated call amount may be created for each skill, skill level, or job title required for a responding communicator. In this manner, by creating prediction data of a call amount for each skill, skill level, and job title, in the schedule creation described hereinafter, it is possible to place a communicator that matches requirements while referring to a skill, skill level, job title, or the like of a candidate to be placed.

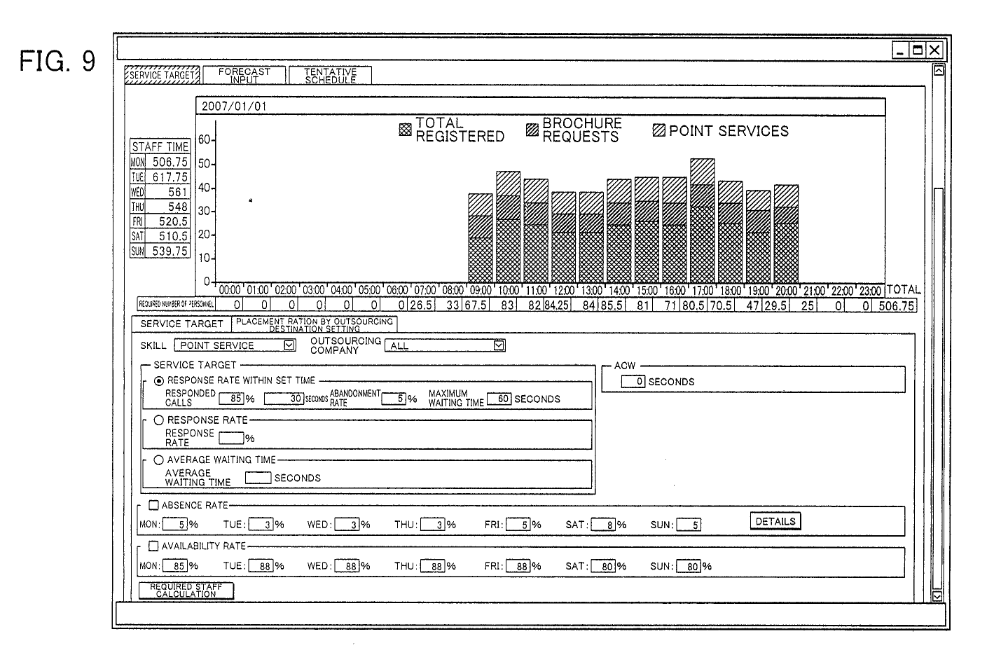

Next, in Step S105, the controller 110 of the server 10 accepts input of a service target using the input unit 130. The service target is set to, for example, any of “Response Rate Within Set Time,” “Response Rate,” or “Average Waiting Time.” Here, “Response Rate Within Set Time” is a rate of calls to which a communicator can respond within a set time, “Abandonment Rate” is a rate at which callers put down a receiver before a communicator responds, “Maximum Waiting Time” is a maximum waiting time until a communicator responds to a call, “Response Rate” is a ratio of calls to which a communicator can respond, and “Average Waiting Time” is an average waiting time until when a communicator can respond to a call. Furthermore, an “absence rate” and “availability rate” are set for each day of the week. These values may be input as specific values by a manager, or may be displayed as values calculated based on past statistics, and suitably edited by the manager. An example of a specific input screen is explained with reference to FIG. 9.

In FIG. 9, “Response Rate Within Set Time” is set as a service target. More specifically, contents of “85% Respond Within 30 Seconds,” “Abandonment Rate: 5%,” and “Maximum Waiting Time: 60 Seconds” are input. Here, ratios differing by day of week are input for the absence rate and the availability rate. In a case of setting a more detailed absence rate, the Details button is pressed, and input in a screen such as that of FIG. 10.

In the example of FIG. 10, the absence rate is set by day of week and by time period.

More specifically, such settings as “Monday, AM: 5%, PM: 3%, Night: 5%, Midnight: 7%” and the like are made.

Absence rates of communicators by day of week and by time period may differ, and therefore by setting in this manner, it is possible to make fine-grained calculations of required personnel.

Based on these kinds of various settings of conditions, in Step S106, the controller 110 of the server 10 creates a schedule.

It should be noted that the storage unit 120 of the server 10 stores a desired weekly holiday and desired shift for each communicator beforehand. In this manner, it is possible for the controller 110 of the server 10 to give priority in consideration to a skill level while adjusting a schedule of each communicator to be a target, also taking into consideration a desired weekly holiday and desired shift (Step S107).

Furthermore, at a time when an early shift or overtime becomes necessary, it is possible to adjust based on data for each communicator. FIG. 11 is one example of various data described above stored for each communicator.

In the example of FIG. 11, that Communicator A has Point Service Level 3 and Registration Change Level 2 is shown. Furthermore, such data as job title, desired weekly holidays, desired shift, absence rate, early shift, and overtime are stored. Person A is “early shift: available,” and therefore, in a situation in which an early shift is necessary, it is possible to assign Person A. In this manner, by using data for each communicator, it is possible to create a schedule reflecting job title, desired weekly holidays, and the like, based on skill data.

It should be noted that the controller 110 of the server 10, using the communication unit 150, transmits report data of recruitment to a terminal 20 of a communicator after schedule creation. In addition, after considering a response to the recruitment from the terminal 20 of the communicator, it is possible to adjust the schedule further.

### Compensation Vacation Period Configuration Processing

FIG. 12 is a flowchart showing a flow of compensation vacation period configuration processing related to one example of a preferred embodiment of the present invention.

A manager of a contact center, during such busy seasons as, for example, Golden Week, may perform assignment for work on a national holiday in preparation for insufficiency of communicators. As a result, it is necessary to set a compensation vacation period (substituted holiday) in exchange for work on a national holiday.

First, in Step S201, the controller 210 of the terminal 20 accepts a designated input of holiday work (work on a national holiday) through the input unit 230, and transmits thereof to the server 10. The designated input adds the communicator to the schedule.

Next, in Step S202, the controller 110 of the server 10 accepts an input of a designated period. The designated period is a period for which obtaining a compensation vacation period (substituted holiday) for the communicator should be set. More specifically, for example, obtaining a compensation vacation period within an outsourced period of time is necessary for an outsourced employee.

Next, in Step S203, the controller 110 of the server 10 extracts a time period configurable for a compensation vacation period, so as not to affect a service target, from among periods for which a compensation vacation period (substituted holiday) can be obtained for the above-described communicator, transmits thereof to the terminal 20, and displays thereof on the display unit 240.

In this manner, by a communicator selecting a compensation vacation period from among time periods configurable for a compensation vacation period, it is possible to maintain a task level.

### Filled Vacancy Rate

The controller 110 of the server 10 displays a filled vacancy rate using the display unit 140. The filled vacancy rate indicates a ratio of a number of communicators actually placed by each outsourcing destination company to a setting of a number to be placed at each outsourcing destination. The setting of the number to be placed at each outsourcing destination is set based on a target share per outsourcing destination for each campaign (task). For example, Outsourcing Destination Companies A at 50% and B at 30%, and one's own company at 20% can be set, and then assigned target numbers of communicators are determined. It should be noted that the target share per each outsourcing destination may be designated by absolute value instead of as a ratio. In a campaign (task) with one hundred communicators, in a case in which tasks are actually performed with an assignment of 50 people to Company A, 30 people to Company B, and 20 people to one's own company, each filled vacancy rate becomes 100%. In the example indicated in FIG. 13, the above-described filled vacancy rate is displayed as a graph easily understood at a glance.

Moreover, by creating a schedule by time period, it is possible to display a filled vacancy rate by time period.

Heretofore, the present invention has been explained with reference to an embodiment; however, the technological scope of the present invention is not limited to the scope described in the above-mentioned embodiment. It is possible to add various modifications or improvements to the above-mentioned embodiment. It is clear from the description of the scope of the claims that an embodiment in which those types of modifications or improvements have been added may be included in the technical scope of the present invention.

1. A method of creating schedules for a plurality of communicators of a contact center by a computer,
wherein the computer stores at least data indicating a skill of each of the plurality of communicators in a storage unit; the method comprising steps of:
accepting a designated input of a number of the communicators to be placed, for each of a plurality of skills of the communicators for each of the time periods of a task, from a manager of the contact center;
further storing, in the storage unit, data indicating a number of personnel who have accepted the designated input for each time period of the task; and
creating a schedule of the plurality of communicators, based on data indicating the stored number of personnel for each time period of the task.

2. The method according to claim 1,
wherein the computer stores, in the storage unit, each skill of the plurality of communicators by dividing into a plurality of levels;
the computer further accepts designated input of the level from the manager, in the step of accepting the designated input;
the computer further stores, in the storage unit, the level for which the designated input was accepted, in the step of storing; and
the schedule is created based on the level further stored, in the step of creating the schedule.

3. The method according to claim 1, wherein:
the computer further stores in the storage unit data indicating a job title for each of the plurality of communicators;
the computer further accepts a designated input of the number of the communicators to be placed for each of the plurality of job titles of the communicators for each of the time periods of the task from the manager, in the step of accepting the designated input;
the computer further stores in the storage unit data indicating the number of personnel for which the designated input was accepted, in the step of storing; and
the computer creates the schedule based on data indicating the job title further stored, in the step of creating the schedule.

4. The method according to claim 1, further comprising steps of the computer:
accepting input of data indicating a desired weekly holiday and a desired shift of the communicator; and
adjusting the created schedule based on data indicating the desired weekly holiday and desired shift for which the input was accepted, in the step of creating the schedule.

5. The method according to claim 1, further comprising
a step of the computer further storing, in the storage unit, a past absence rate of the communicator by day of week or by time period,
wherein the computer creates the schedule based on the stored absence rate, in the step of creating the schedule.

6. The method according to claim 1, further comprising
a step of the computer calculating and displaying a rate of filled vacancy based on the number of personnel for whom the specific input was accepted, and the number of personnel actually placed.

7. The method according to claim 1, further comprising steps of the computer:
accepting an input from the manager converting a portion of a vacation period of the communicator to a work period in relation to the created schedule;
accepting a designation of a predetermined period; and
calculating and displaying a period which can be set for a compensation vacation period of the communicator in relation to the created schedule in the predetermined period for which a designation was accepted.

8. The method according to claim 1, wherein the computer:
further stores, in the storage unit, early shift and overtime availability data indicating whether each communicator is available for an early shift and/or overtime, and maximum overtime hour data indicating available maximum overtime hours, respectively; and
creates the schedule based on the early shift and overtime availability data and the maximum overtime hour data further stored, in the step of creating the schedule.

9. The method according to claim 1, further comprising steps of the computer:
accepting from the manager designated input of each service target upon designation of the skill for each time period of each task; and
further storing, in the storage unit, data indicating the service target for which the designated input has been accepted upon designation of the skill for each time period of the task,
wherein the computer creates the schedule based on data indicating the service target further stored, in the step of creating the schedule.

10. A computer that creates a schedule for a plurality of communicators of a contact center,
wherein at least data indicating a skill for each of the plurality of communicators is stored in a storage unit; the computer comprising:
a unit configured to accept a designated input of a number of the communicators to be placed for each of a plurality of skills of the communicators for each time period of the task from the manager of the contact center;
a unit configured to store further, in the storage unit data indicating the number of personnel for whom the designated input was accepted for each time period of the task; and
a unit configured to create a schedule for the plurality of communicators based on data indicating the stored number of personnel for each time period of the task.

11. The method according to claim 1, wherein the computer:
further stores, in the storage unit, early shift and overtime availability data indicating whether each communicator is available for one of an early shift and overtime, and maximum overtime hour data indicating available maximum overtime hours, respectively; and
creates the schedule based on the early shift and overtime availability data and the maximum overtime hour data further stored, in the step of creating the schedule.
